(19) United States
(12) Patent Application Publication
(10) Pub. No.: US 2014/0184528 A1
(43) Pub. Date: Jul. 3, 2014

(54) METHOD FOR IDENTIFYING GESTURE

(71) Applicant: ELAN MICROELECTRONICS CORPORATION, Hsin Chu (TW)

(72) Inventors: Jian-Wei CHEN, New Taipei City (TW); Chien-Chou CHEN, Taipei City (TW); Ying-Chieh CHUANG, Taipei City (TW)

(73) Assignee: ELAN MICROELECTRONICS CORPORATION, Hsin Chu (TW)

(21) Appl. No.: 13/855,901

(22) Filed: Apr. 3, 2013

(30) Foreign Application Priority Data
Jan. 2, 2013 (TW) 102100014

(51) Int. Cl. G06F 3/041

(52) U.S. Cl. CPC G06F 3/0416
USPC 345/173

(57) ABSTRACT

The method for identifying a gesture on a touch panel has steps of receiving position information of at least three touch objects; determining whether the position information of any one of the at least three touch objects has been changed; if the position information of any one of the at least three touch objects has been changed, calculating a first sum of distances between the at least three touch objects before moving, then calculating a second sum of distances between the at least three touch objects after moving, and calculating a variation between the first sum and the second sum; and determining whether the variation exceeds a default value, and if the variation exceeds a default value, a first gesture is identified. The first gesture is identified as a grab gesture or a spread gesture based on whether the variation is positive or negative.

### BACKGROUND OF THE INVENTION

1. Field of the invention

The present invention relates to a method for identifying a gesture and more particularly to a method for distinguishing a grab/spread gesture on a touch panel.

2. Description of Related Art

A touch panel makes it easy for a user to input or select a function shown on a screen of an electronic device. Hence, many external input devices such as a keyboard or a mouse are replaced by touch panels.

For diversifications in operating of a touch panel, many operating systems of electronic devices provide a convenient function mode by executing gestures on the touch panel. For example, a slide gesture is used for displaying a hidden function bar and a grab/spread gesture is/are used for closing or showing a current window. With reference to the Lion operating system of an Apple notebook computer 20 as shown in FIGS. 8A and 8B, the Lion operating system supports a grab/spread gesture function. When a grab gesture is identified on a touch panel 10 installed with the Lion operating system, applications arrayed in a single row0211 on a monitor 21 of the notebook computer 20 is turned to multiple rows 212 on a desktop of the notebook computer 20. The desktop of the notebook computer 20 is thus made resembling a user interface of a smart phone or a tablet PC. When a spread gesture is identified on a touch panel 10, the Lion operating system makes the monitor 21 return from display of a current window to the desktop of the notebook 20 as shown in FIGS. 9A and 9B.

Using grab/spread gestures on the touch panel indeed enables the users to conveniently and promptly return to the desktop of the notebook 20. However, the grab/spread gesture is not easy to execute on the Apple touch panel. With reference to FIG. 8A, first of all, four touch objects must be detected on the touch panel simultaneously, and all of the four touch objects must respectively move in different directions, such as moving toward a center as shown in FIG. 8B, then the grab gesture is executed on the touch panel. Therefore, when all of the four touch objects move in a same direction, the gesture is likely to be misidentified as a slide gesture on the touch panel. In addition, when any one of the touch objects is motionless and the other three touch objects are approaching the motionless object, the grab in gesture cannot be identified on the touch panel, either. Therefore, the grab/spread gesture is relatively hard to be executed on the touch panel. The conventional method for distinguishing a grab/spread gesture on the touch panel have to be improved.

### SUMMARY OF THE INVENTION

The main objective of the invention is to provide a method for identifying a gesture, which is cable of distinguishing a grab/spread gesture on a touch panel.

The method for identifying a gesture on a touch panel has steps of:

receiving position information of at least three touch objects;

determining whether the position information of any one of the at least three touch objects has been changed;

if the position information of any one of the at least three touch objects has been changed, calculating a first sum of distances between the at least three touch objects before moving, then calculating a second sum of distances between the at least three touch objects after moving, and calculating a variation between the first sum and the second sum; and

determining whether the variation between the first sum and the second sum exceeds a default value, if the variation exceeds the default value, identifying a first gesture.

Another embodiment of the method for identifying a gesture on a touch panel has steps of:

receiving position information of at least three touch objects;

determining whether the position information of any one of the at least three touch objects has been changed;

if the position information of any one of the at least three touch objects has been changed, determining moving directions of each of the at least three touch objects;

determining whether the moving direction of any one of the at least three touch objects is different from the moving directions of the other touch objects, if the moving direction of any one of the at least three touch objects is different from the moving directions of the other touch objects, calculating a first sum of distances between the at least three touch objects before moving, then calculating a second sum of distances between the at least three touch objects after moving, and calculating a variation between the first sum and the second sum; and

determining whether the variation between the first sum and the second sum exceeds a default value, if the variation exceeds the default value, a first gesture is identified.

In conclusion, the two embodiments of the method for identifying a gesture both determines whether the position information of any one of the at least three touch objects has been changed. If the position information of any one of the at least three touch objects has been changed, calculating a first sum of distances between the at least three touch objects before moving, then calculating a second sum of distances between the at least three touch objects after moving, and calculating a variation between the first sum and the second sum, and then determining whether the variation between the first sum and the second sum exceeds a default value. If the variation between the first sum and the second sum exceeding a default value, identifying a first gesture. The first gesture is identified as a grab gesture or a spread gesture based on whether the variation between the first sum and the second sum is positive or negative. Therefore the present invention only needs three fingers and an adequate variation of the position information of the at least three touch objects to execute a grab/spread gesture on the touch panel.

### BRIEF DESCRIPTION OF THE DRAWINGS

FIG. 1 is a flowchart of a first embodiment of a method for identifying a gesture on a touch panel in accordance with the present invention;

FIG. 2A is a schematic view of at least three touch objects by the step in FIG. 1;

FIG. 2B is an operational schematic view of a first gesture by the method in FIG. 1, showing a grab gesture;

FIG. 2C is an operational schematic view of a first gesture by the step in FIG. 1, showing a spread gesture;

FIG. 3 is a flowchart of a second embodiment of a method for identifying a gesture on a touch panel in accordance with the present invention;

FIG. 4 is an operational schematic view of a first gesture by the method in FIG. 3, showing a grab gesture;

FIG. 5 is a flowchart of a third embodiment of a method for identifying a gesture on a touch panel in accordance with the present invention;

FIG. 6 is an operational schematic view of a first gesture by the method in FIG. 5, showing a grab gesture;

FIGS. 7A to 7C are operational schematic views of the grab in gesture in FIG. 6, showing an angle between the touch objects before moving and an angle between the touch objects after moving;

FIGS. 8A and 8B are operational schematic views of a Lion operating system of an Apple notebook computer, showing a grab gesture; and

FIGS. 9A and 9B are operational schematic views of the Lion operating system of the Apple notebook computer, showing a spread gesture.

### DETAILED DESCRIPTION OF THE PREFERRED EMBODIMENTS

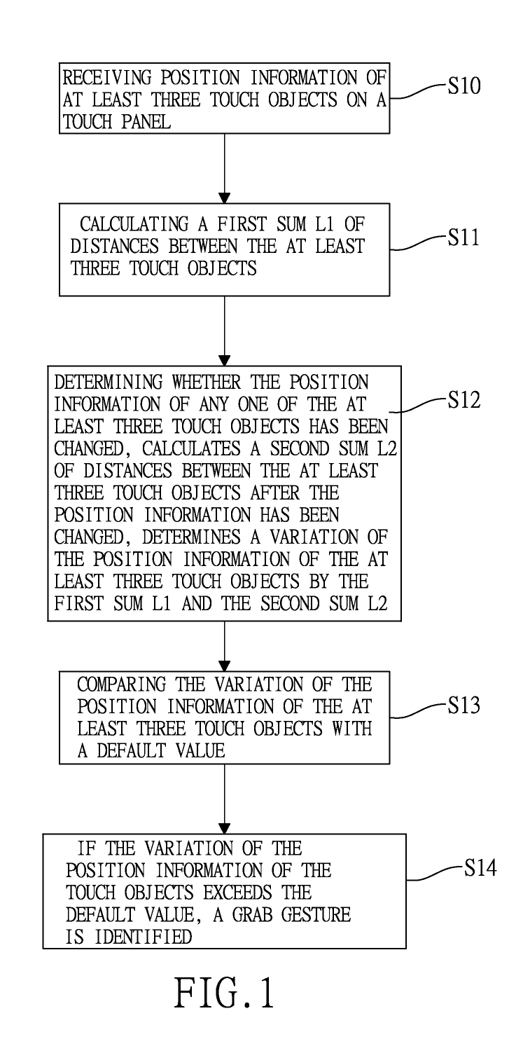

With reference to FIGS. 1, a preferred embodiment of a method for identifying a gesture on a touch panel in accordance with the present invention has the following steps.

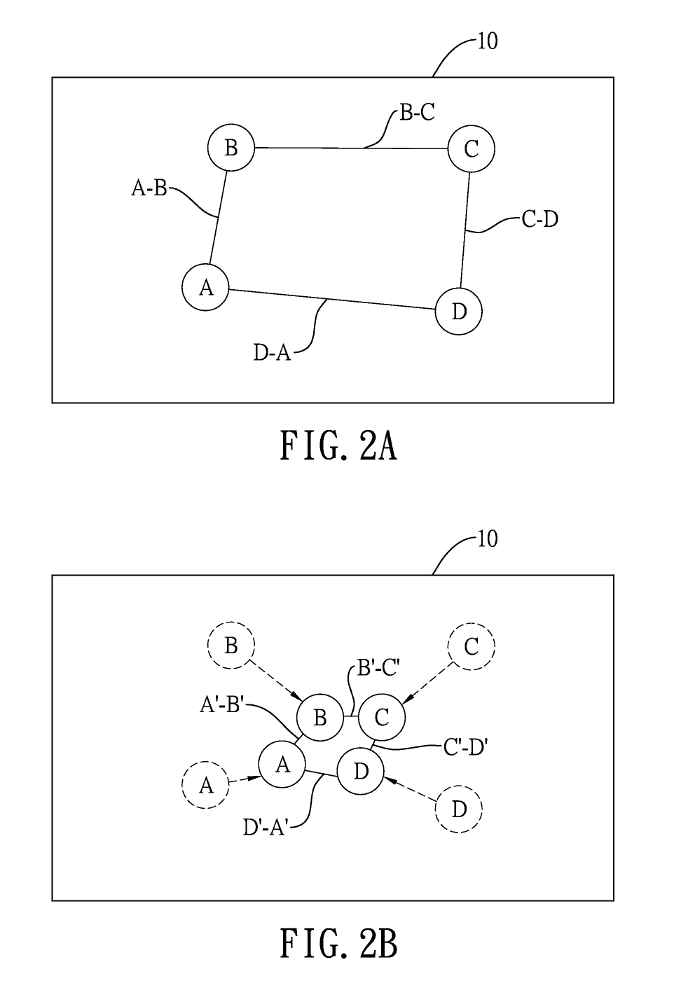

Receiving position information of at least three touch objects on the touch panel 10 (S10); in the preferred embodiment, the method for identifying a gesture comprises four touch objects A, B, C, D on the touch panel 10 as shown in FIG. 2A.

Calculating a first sum L1 of distances A-B, B-C, C-D, D-A between the touch objects A, B, C, D (S11).

Determining whether the position information of any one of the touch objects A, B, C, D has been changed, which means to receive the position information of the touch objects A, B, C, D at a first time point and a second time point. If the position information of any one of the touch objects A, B, C, D at the first time point is different from that at the second time point, the touch objects A, B, C, D have been moved. Then calculating a second sum L2 of distances A′-B′, B′-C′, C′-D′, D′-A′ between the touch objects A′, B′, C′, D′ as shown in FIGS. 2B, and comparing the first sum L1 of distances A-B, B-C, C-D, D-A between the touch objects A, B, C, D at the first time point with the second sum L2 of distances A′-B′, B′-C′, C′-D′, D′-A′ between the touch objects A′, B′, C′, D′ at the second time point to obtain the variation of the position information of the touch objects A, B, C, D, that is, a difference between L1−L2 or L2−L1 equals the variation of the position information of the touch objects A, B, C, D (S12).

Taking an absolute value of the difference between L1−L2 or L2−L1 and comparing the absolute value of the difference between L1−L2 or L2−L1 with a default value (S13).

If the variation of the position information of the touch objects exceeds the default value, a first gesture is identified (|L1−L2|>LTH or |L2−L1|>LTH) (S14).

Furthermore, by a positive value or a negative value of the difference between L1−L2 or L2−L1, the first gesture is determined as a grab gesture or a spread gesture by the following formulas:

The grab gesture (as shown in FIG. 2B): L1−L2>0, or L2−L1<0.

The spread gesture (as shown in FIG. 2C): L1−L2<0, or, L2−L1>0. Seen from the above, the present invention identifies the grab/spread gesture by whether the variation of the at least three touch objects exceeds the default value, and provides an easy identification of the grab/spread gesture to the touch panel 10, wherein the sum of distances A-B, B-C, C-D, D-A between the touch objects A, B, C, D in the first embodiment does not include distances A-C or B-D (diagonal distances). However, the distances A-C or B-D can also be included in a sum of distances in other preferred embodiments, not restricted by the first embodiment.

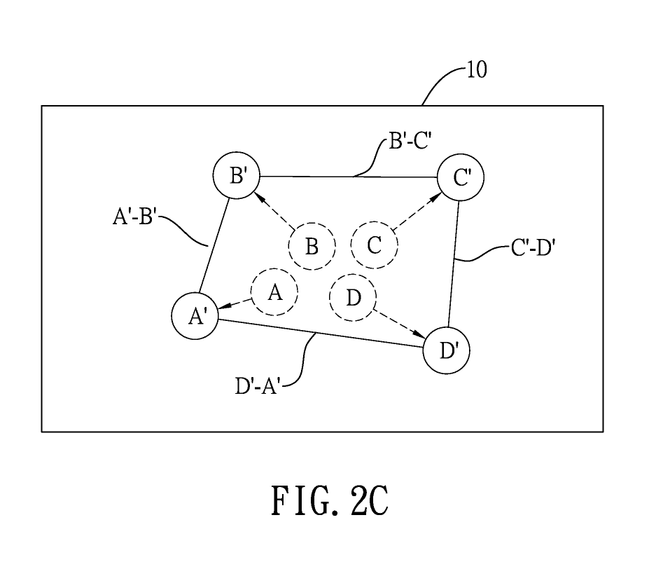

In addition, the touch panel 10 also supports other multi-finger touch gestures. In order to avoid an inadvertent execution of other multi-finger touch gestures, a second preferred embodiment of a method for identifying a gesture on a touch panel as shown in FIG. 3 is further provided and has the following steps.

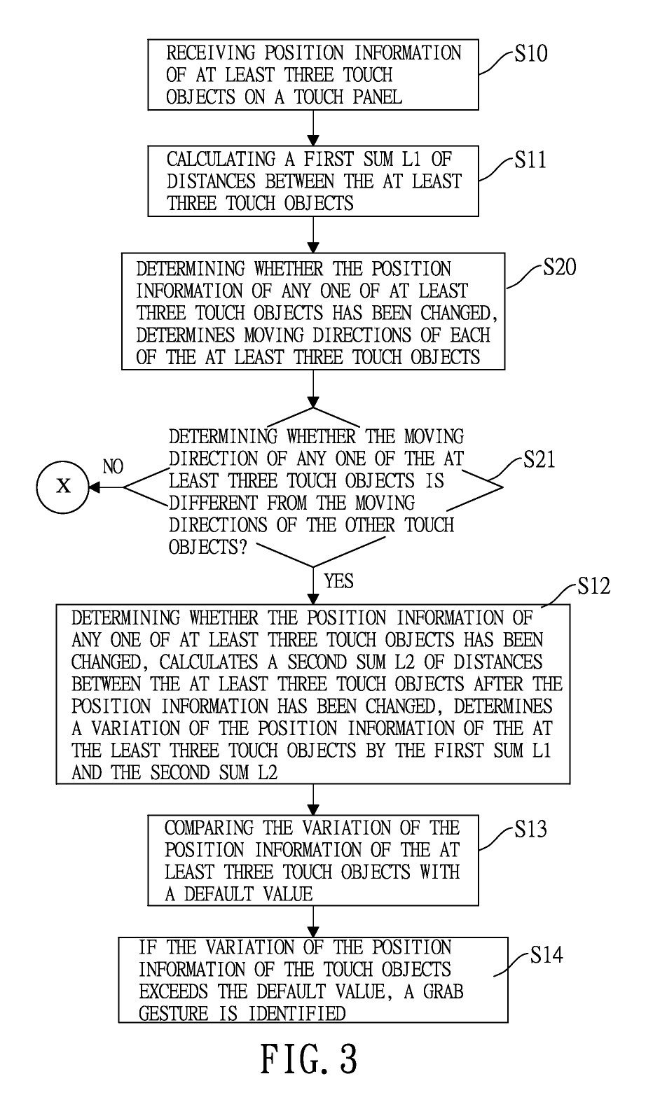

Receiving position information of at least three touch objects on the touch panel 10 (S10); in the second preferred embodiment, the method for identifying a gesture comprises four touch objects A, B, C, D on the touch panel 10 as shown in FIG. 4.

Calculating a sum L1 of distances A-B, B-C, C-D, D-A between the touch objects A, B, C, D (S11).

Obtaining moving directions of each touch objects A, B, C, D through the position information of the touch objects A, B, C, D when any one of the touch objects A, B, C, D has moved (S20).

Determining whether the moving direction of any one of the touch objects A, B, C, D is different from the moving directions of the other touch objects A, B, C, D (S21). If the moving direction of any one of the touch objects A, B, C, D is different from the moving directions of the other touch objects A, B, C, D, the gesture is similar to the grab/spread gesture and distinguishable from other multi-finger touch gestures.

calculating a second sum L2 of distances A′-B′, B′-C′, C′-D′, D′-A′ between the touch objects A′, B′, C′, D′ to obtain a variation of the position information of the touch objects A, B, C, D (S12).

Comparing the variation of the position information of the touch objects A, B, C, D with a default value to determine whether the variation of the position information of the touch objects A, B, C, D exceeds the default value (S13).

If the variation of the position information of the touch objects A, B, C, D exceeds the default value, a first gesture is identified (S14).

In addition, the step (S21) can be executed before or after the step (S13). If the step (S21) is executed before the step (S13), the step (S13) and the step (S14) are executed only if the step (S21) has a positive determination result. If the step (S21) is executed after the step (S13), the step (S21) and the step (S14) are executed only if the step (S13) has a positive determination result. The grab/spread gesture is identified only if the step (S13) and the step (S21) both have positive determination results.

As for determining the moving directions of the touch objects A, B, C, D, set the initial positions information of each touch objects A, B, C, D as coordinate origins, and then establish multiple coordinate systems based on the respective original coordinate origins, wherein each coordinate system has four quadrants (as quadrants I, II , III, IV shown in FIG. 4).

Determine which quadrant I, II, III, IV the moving directions of each touch object A, B, C, D respectively belong to, i.e. determining the moving directions of each touch object A, B, C, D by quadrant. To increase accuracy in determining moving directions of each touch object A, B, C, D, angle ranges of the quadrants I, II, III, IV can be adjusted to coordinate with a user habit. The angle ranges of the first and the third quadrants I, III as shown in FIG. 4 are adjusted to be bigger than the angle ranges of the second and fourth quadrants II, IV. Therefore, the touch objects A′, B′ are located in the first quadrant I and the touch objects C′, D′ are located in the third quadrant III according to the moving directions of each touch object A, B, C, D, and thereby satisfying the criteria that a moving direction of any one of the touch objects A, B, C, D is different from the moving directions of the other touch objects A, B, C, D. Accordingly, the gesture as shown in FIG. 4 is identified as the grab/spread gesture.

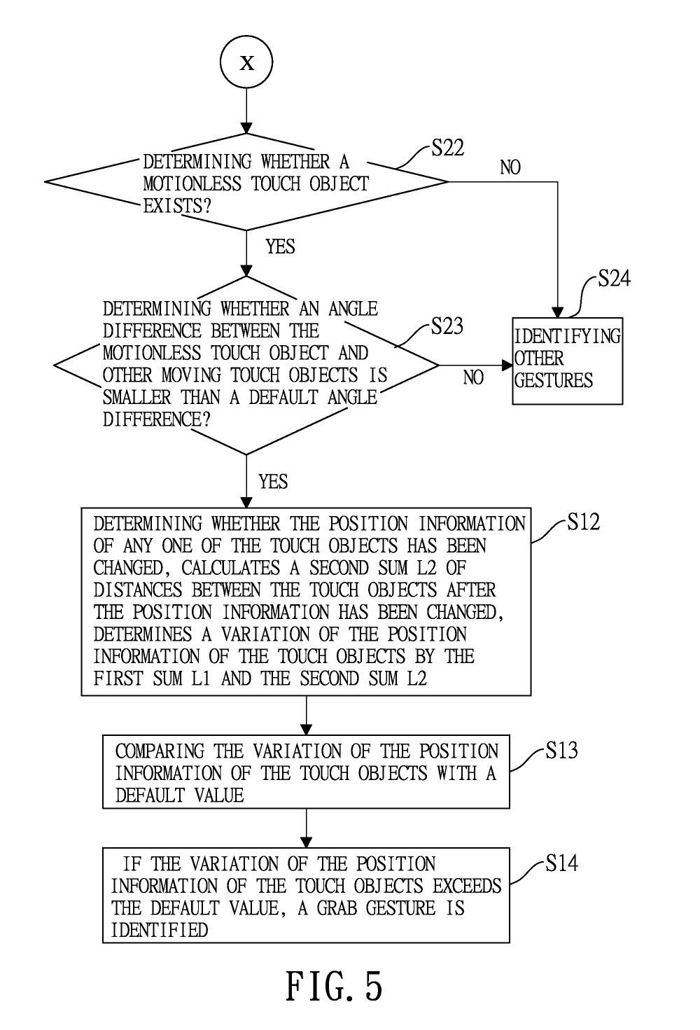

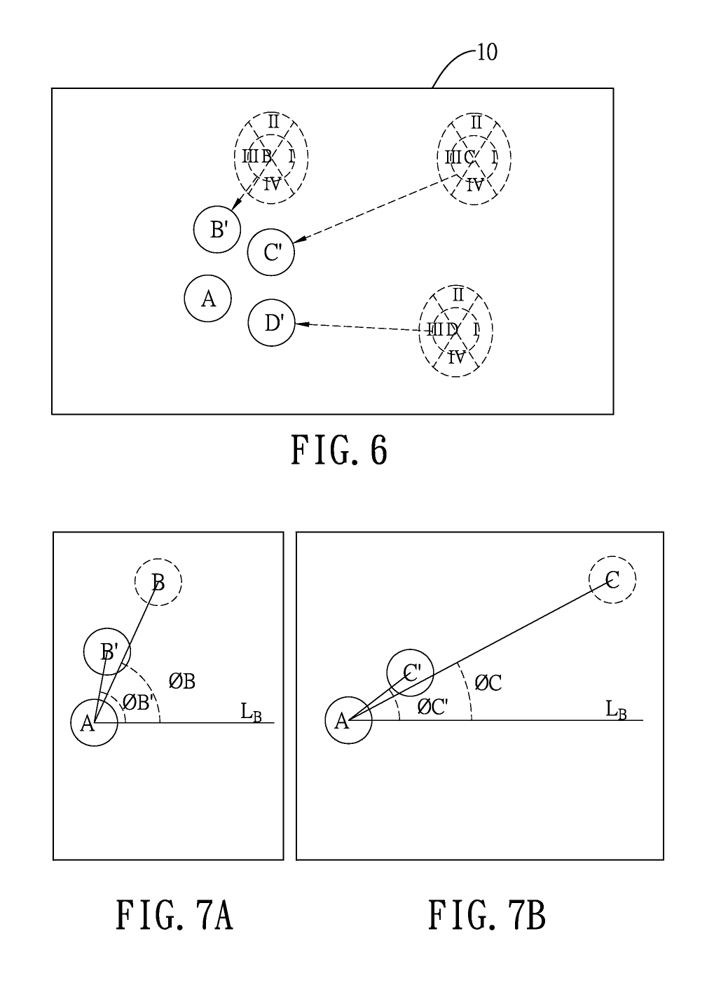

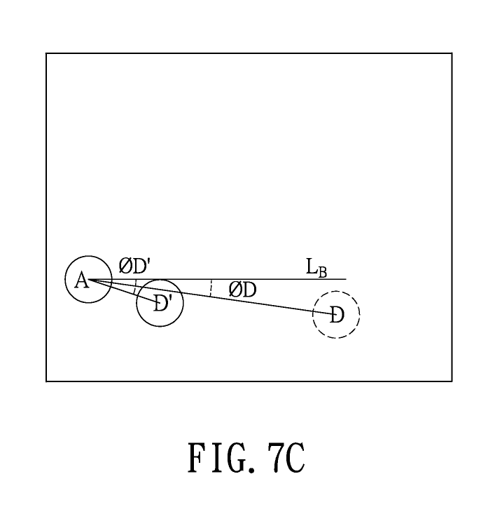

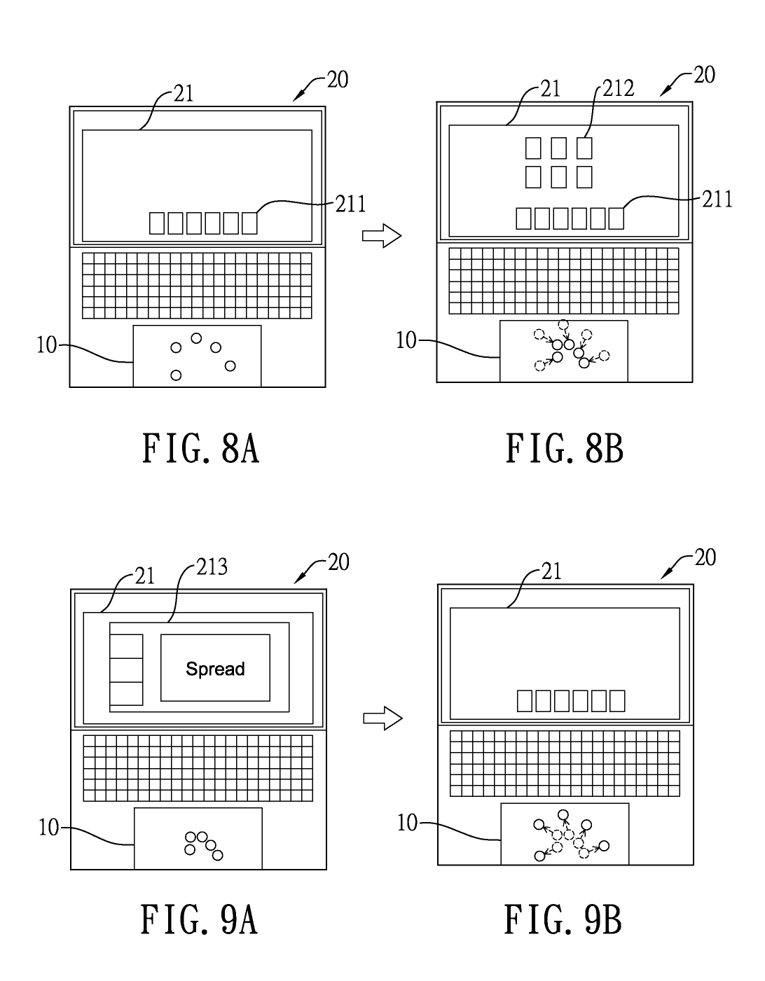

Furthermore, the grab/spread gesture also includes a situation that one of the at least three touch objects is motionless, and the other touch objects are moving toward the motionless touch object. With reference to FIGS. 6, a touch object A is motionless, and the other touch objects B, C, D move toward the motionless touch object A. Accordingly, the step (S21) has a negative determination result since the moving touch objects B, C, D are moving in a same direction, but the situation shall still be identified as the grab/spread gesture.

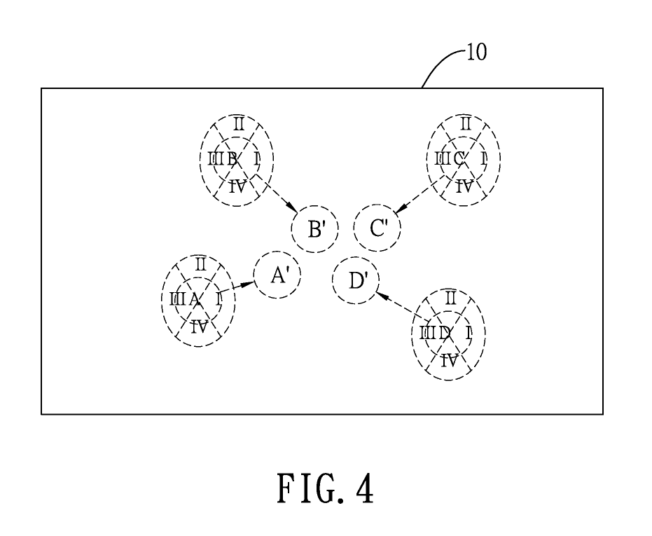

With further reference to FIG. 3, if the step (S21) has a negative determination result, further execute an angle-determination step (X) as shown in FIG. 5 to increase accuracy of the present invention, and the angle-determination (X) has the following steps.

With reference to FIG. 6, first determine whether a motionless touch object A exists (S22).

If a motionless object A exists, calculate a first angle. A first line is constituted between a position of each moving touch object B, C, D before moving and a position of the motionless touch object, and then an angle between the first line and a reference line is calculated, wherein a straight path between A and B is defined as the first line, and the first angle is defined between the first line and the reference line. Calculating a second angle. A second line is constituted between a position of each moving touch object B′, C′, D′ after moving and the position of the motionless touch object A, then an angle between the second line and the reference line is calculated and defined as the second angle, then an angle difference between the first angle and the second angle is calculated, that is, a position of the moving touch object B before moving and a position of the moving touch object B′ after moving constitute the first and second lines A-B, A-B′ respectively with a position of the motionless touch object A, and the first and second lines A-B, A-B′ constitute the first and second angles ØB,ØB′ between a reference line LB. Similarly, a position of the moving touch object C before moving and a position of the moving touch object C′ after moving constitute the first and second lines A-C, A-C′ with the position of the motionless touch object A, and the first and second lines A-C, A-C′ constitute the first and second angles ØC,ØC′ between the reference line LB. A position of the moving touch object D before moving and a position of the moving touch object D′ after moving constitute the first and second lines A-D, A-D′ with the position of the motionless touch object A, and the first and second lines A-D, A-D′ constitute the first and second angles ØD, ØD' between the reference line LB. The angle differences between the first and second angles ØB, ØB′, between the first and second angles ØC,ØC′, and between the first and second angles ØD,ØD′ are calculated respectively to determine whether each angle difference is smaller than a default angle difference(such as 10 degrees) (S23).

If each angle difference is smaller than a default angle difference, that is, the moving touch objects B, C, D are moving toward the motionless touch object A, the gesture is similar to the grab gesture, the first sum L1 and the second sum L2 are calculated according to the position information of the touch objects A, B, C, D before moving and the position information of the touch objects A′, B′, C′, D′ after moving to obtain the variation of the position information of the touch objects A, B, C, D (S12).

Then determine whether the variation of the position information of the touch objects A, B, C, D exceeds the default value (S13).

If the variation of the position information of the touch objects A, B, C, D exceeds the default value, the gesture is identified as the grab gesture (S14).

If the motionless touch object A does not exist, and the moving directions of each moving touch object are all the same, the gesture is not identified as the grab/spread gesture and an identification of other gestures is initiated (S24).

Or, the motionless touch object A exists, but the angle differences of the touch objects A, B, C, D exceed the default angle difference, the gesture is not identified as the grab gesture and an identification of other gestures is initiated (S24).

Due to the determining of the angle difference, a scroll gesture will not be executed inadvertently, and accuracy is increased for the method for identifying a gesture of the present invention.

In conclusion, the method for identifying a gesture of the present invention determines the sum of the distances between the touch objects before moving and the sum of the distances after moving, and then calculates the variation between the sum before moving and the sum after moving. If the variation exceeds the default value, the first gesture is identified. In addition, the first gesture is identified as the grab gesture or the spread gesture depending on whether the variation is positive or negative. Hence, the present invention only needs three fingers and an adequate variation of the position information of the at least three touch objects to execute a grab/spread gesture on the touch panel.

What is claimed is:

1. A method for identifying a gesture comprising:
receiving position information of at least three touch objects;
determining whether the position information of any one of the at least three touch objects has been changed;
if the position information of any one of the at least three touch objects has been changed, calculating a first sum of distances between the at least three touch objects before moving, then calculating a second sum of distances between the at least three touch objects after moving, and calculating a variation between the first sum and the second sum; and
determining whether the variation between the first sum and the second sum exceeds a default value, and if the variation exceeds the default value, identifying a first gesture.

2. The method for identifying a gesture as claimed in claim 1, wherein the first gesture includes a grab gesture and a spread gesture; the variation is a difference between the first sum and the second sum; and after the step of determining whether the variation between the first sum and the second sum exceeds a default value, the method further comprises steps of:
if the difference between the first sum and the second sum is positive, the first gesture is identified as the grab gesture; and
if the moving direction of any one of the at least three touch objects is different from the moving directions of the other touch objects, the difference between the first sum and the second sum is negative, the first gesture is identified as the spread gesture.

3. The method for identifying a gesture as claimed in claim 1, wherein the step of determining whether the position information of any one of the at least three touch objects has been changed further comprises steps of:
determining whether any one of the at least three touch object is motionless if the position information of any one of the at least three touch objects has been changed; and
if any one of the at least three touch object is motionless, calculating the variation between the first sum and the second sum.

4. The method for identifying a gesture as claimed in claim 1, further comprising steps of:
determining whether a moving direction of any one of the at least three touch objects is different from moving directions of other touch objects among the at least three tough objects if the position information of any one of the at least three touch objects has been changed; and
if the moving direction of any one of the at least three touch objects is different from the moving directions of the other touch objects and if the variation between the first sum and the second sum exceeds the default value, the first gesture is identified.

5. The method for identifying a gesture as claimed in claim 4, wherein the step of determining whether the moving direction of any one of the at least three touch objects is different from the moving directions of the other touch objects comprises steps of:
setting initial positions of the at least three touch objects as multiple coordinate origins, respectively establishing a coordinate system from each of the coordinate origins, and dividing each coordinate system into four quadrants;
determining the quadrants to which the moving direction of each of the at least three touch objects belong if the position information of any one of the at least three touch objects has been changed; and
if the quadrant to which the moving direction of any one of the at least three touch objects belongs is different from the quadrants to which the moving directions of the other touch objects belong, the first gesture is identified.

6. The method for identifying a gesture as claimed in claim 5, wherein angle ranges of the quadrants in each coordinate system are different.

7. The method for identifying a gesture as claimed in claim 4, wherein if the moving direction of any one of the at least three touch objects is not different from the moving directions of the other touch objects and any one of the at least three touch objects is motionless in the step of determining whether the moving direction of any one of the at least three touch objects is different from the moving directions of the other touch objects; the method further comprises the following steps:
calculating a first angle between a motionless touch object and each moving touch object before moving, and calculating a second angle between the motionless touch object and each moving touch object after moving;
calculating an angle difference between the first angle and the second angle; and
determining whether the angle difference between the first angle and the second angle is smaller than a default angle difference, and if the angle difference between the first angle and the second angle is smaller than the default angle difference, the first gesture is identified.

8. The method for identifying a gesture as claimed in claim 7, wherein the step of calculating the angle difference between the first angle and the second angle comprises the following steps:
calculating the first angle, wherein a straight path between a position of each moving touch object before moving and a position of the motionless touch object constitutes a first line, and the first angle is defined between the first line and a reference line;
calculating the second angle, wherein a straight path between a position of each moving touch object after moving and the position of the motionless touch object constitutes a second line, and the second angle is defined between the second line and the reference line; and
calculating a difference between the first angle and the second angle to be determined as the angle difference.

9. A method for identifying a gesture comprising:
receiving position information of at least three touch objects;
determining whether the position information of any one of the at least three touch objects has been changed;
if the position information of any one of the at least three touch objects has been changed, determining moving directions of the at least three touch objects;
determining whether the moving direction of any one of the at least three touch objects is different from the moving directions of other touch objects among the at least three touch objects; if the moving direction of any one of the at least three touch objects is different from the moving directions of the other touch objects, calculating a first sum of distances between the at least three touch objects before moving, then calculating a second sum of distances between the at least three touch objects after moving, and calculating a variation between the first sum and the second sum; and
determining whether a variation between the first sum and the second sum exceeds a default value, and if the variation exceeds the default value, identifying a first gesture.

10. The method for identifying a gesture as claimed in claim 9, wherein the step of determining whether the moving direction of any one of the touch objects is different from the moving directions of the other touch objects comprises:
setting initial positions of the at least three touch objects as multiple coordinate origins, and respectively establishing a coordinate system from each of the coordinate origins, and dividing each coordinate system into four quadrants;
determining the quadrants to which the moving direction of each of the at least three touch objects belong if the position information of any one the at least three touch objects has been changed; and
if the quadrant to which the moving direction of any one of the at least three touch objects belongs is different from the quadrants to which the moving directions of the other touch objects belong, the first gesture is identified.

11. The method for identifying a gesture as claimed in claim 10, wherein angle ranges of the quadrants in each coordinate system are different.

12. The method for identifying a gesture as claimed in claim 9, wherein if the moving direction of any one of the at least three touch objects is not different from the moving directions of the other touch objects and any one of the at least three touch objects is motionless in the step of determining whether the moving direction of any one of the at least three touch objects is different from the moving directions of the other touch objects; the method further comprises the following steps:
calculating a first angle between a motionless touch object and each moving touch object before moving, and calculating a second angle between the motionless touch object and each moving touch object after moving;
calculating an angle difference between the first angle and the second angle; and
determining whether the angle difference between the first angle and the second angle is smaller than a default angle difference, and if the angle difference between the first angle and the second angle is smaller than the default angle difference, calculating the variation of the position information of the at least three touch objects.

13. The method for identifying a gesture as claimed in claim 10, wherein if the moving direction of any one of the at least three touch objects is not different from the moving directions of the other touch objects and any one of the at least three touch objects is motionless in the step of determining whether the moving direction of any one of the at least three touch objects is different from the moving directions of the other touch objects; the method further comprises the following steps:
calculating a first angle between a motionless touch object and each moving touch object before moving, and calculating a second angle between the motionless touch object and each moving touch object after moving;
calculating an angle difference between the first angle and the second angle; and
determining whether the angle difference between the first angle and the second angle is smaller than a default angle difference, and if the angle difference between the first angle and the second angle is smaller than the default angle difference, calculating the variation of the position information of the at least three touch objects.

14. The method for identifying a gesture as claimed in claim wherein if the moving direction of any one of the at least three touch objects is not different from the moving directions of the other touch objects and any one of the at least three touch objects is motionless in the step of determining whether the moving direction of any one of the at least three touch objects is different from the moving directions of the other touch objects; the method further comprises the following steps:
calculating a first angle between a motionless touch object and each moving touch object before moving, and calculating a second angle between the motionless touch object and each moving touch object after moving;
calculating an angle difference between the first angle and the second angle; and
determining whether the angle difference between the first angle and the second angle is smaller than a default angle difference, and if the angle difference between the first angle and the second angle is smaller than the default angle difference, calculating the variation of the position information of the at least three touch objects.

15. The method for identifying a gesture as claimed in claim 12, wherein the step of calculating an angle difference between the first angle and the second angle comprises the following steps:
calculating the first angle, wherein a straight path between a position of each moving touch object before moving and a position of the motionless touch object constitutes a first line, and the first angle is defined between the first line and a reference line;
calculating the second angle, wherein a straight path between a position of each moving touch object after moving and the position of the motionless touch object constitutes a second line, and the second angle is defined between the second line and the reference line; and
calculating a difference between the first angle and the second angle to be determined as the angle difference.

16. The method for identifying a gesture as claimed in claim 13, wherein the step of calculating an angle difference between the first angle and the second angle comprises the following steps:
calculating the first angle, wherein a straight path between a position of each moving touch object before moving and a position of the motionless touch object constitutes a first line, and the first angle is defined between the first line and a reference line;
calculating the second angle, wherein a straight path between a position of each moving touch object after moving and the position of the motionless touch object constitutes a second line, and the second angle is defined between the second line and the reference line; and
calculating a difference between the first angle and the second angle to be determined as the angle difference.

17. The method for identifying a gesture as claimed in claim 14, wherein the step of calculating an angle difference between the first angle and the second angle comprises the following steps:
calculating the first angle, wherein a straight path between a position of each moving touch object before moving and a position of the motionless touch object constitutes a first line, and the first angle is defined between the first line and a reference line;
calculating the second angle, wherein a straight path between a position of each moving touch object after moving and the position of the motionless touch object constitutes a second line, and the second angle is defined between the second line and the reference line; and
calculating a difference between the first angle and the second angle to be determined as the angle difference.

18. The method for identifying a gesture as claimed in claim 9, wherein the first gesture includes a grab gesture and a spread gesture; the variation equals a difference between the first sum and the second sum; and after the step of determining whether the variation between the first sum and the second sum exceeds the default value, the method further comprises steps of:
if the difference between the first sum and the second sum is positive, the first gesture is identified as the grab gesture; and
if the difference between the first sum and the second sum is negative, the first gesture is identified as the spread gesture.

19. A method for identifying a gesture comprising:
receiving position information of at least three touch objects at a first time point;
receiving position information of the at least three touch objects at a second time point;
calculating a first sum of distances between the at least three touch objects at the first time point, then calculating a second sum of distances between the at least three touch objects at the second time point, and calculating a variation between the first sum and the second sum; and
determining whether the variation between the first sum and the second sum exceeds a default value, and if the variation between the first sum and the second sum exceeds the default value, identifying a first gesture.

20. The method for identifying a gesture as claimed in claim 19, wherein the first gesture includes a grab gesture and a spread gesture; the variation represents a difference between the first sum and the second sum; after the step of determining whether the variation between the first sum and the second sum exceeds a default value, the method further comprises steps of:
if the difference between the first sum and the second sum is positive, identifying the first gesture as the grab gesture; and
if the difference between the first sum and the second sum is negative, identifying the first gesture as the spread gesture.

21. The method for identifying a gesture as claimed in claim 19 further comprises following steps before the steps of calculating the variation between the first sum and the second sum:
determining whether the position information of the at least three touch objects at the first and second time points are different;
determining whether any one of the at least three touch objects is motionless if the position information of the at least three touch objects at the first and second time points are different; and
if any one of the at least three touch object is motionless the variation between the first sum and the second sum is calculated.

22. The method for identifying a gesture as claimed in claim 19 further comprises following steps before the steps of calculating the variation between the first sum and the second sum:
determining whether the position information of the at least three touch objects at the first and second time points are different;
determining moving directions of the at least three touch objects if the position information of the at least three touch objects at the first and second time points are different;
determining whether the moving direction of any one of the at least three touch objects is different from the moving directions of other touch objects among the at least three touch objects; and
if the moving direction of any one of the at least three touch objects is different from the moving directions of the other touch objects and if the variation between the first sum and the second sum exceeds the default value, the first gesture is identified.

23. The method for identifying a gesture as claimed in claim 22, wherein the step of determining whether the moving direction of any one of the touch objects is different from the moving directions of the other touch objects comprises:
setting initial positions of each of the at least three touch objects as coordinate origins, respectively establishing a coordinate system from each of the coordinate systems, and then dividing each coordinate origin into four quadrants;
determining the quadrants to which the moving direction of each of the at least three touch objects belong if the position information of any one of the at least three touch objects has been changed; and
if the quadrant to which the moving direction of any one of the at least three touch objects belongs is different from the quadrants to which the moving directions of the other touch objects belong, the first gesture is identified.

24. The method for identifying a gesture as claimed in claim 23, wherein angle ranges of the quadrants in each coordinate system are different.

25. The method for identifying a gesture as claimed in claim 21, wherein if the moving direction of any one of the at least three touch objects is not different from the moving directions of the other touch objects and if any one of the at least three touch objects is motionless in the step of determining whether the moving direction of any one of the at least three touch objects is different from the moving directions of the other touch objects; the method further comprises the following steps:
calculating a first angle between a motionless touch object and each moving touch object at the first time point, and calculating a second angle between the motionless touch object and each moving touch object at the second time point;
calculating an angle difference between the first angle and the second angle; and
determining whether the angle difference between the first angle and the second angle is smaller than a default angle difference, and if the angle difference between the first angle and the second angle is smaller than the default angle difference, calculating the variation of the position information of the at least three touch objects.

26. The method for identifying a gesture as claimed in claim 25, wherein the step of calculating an angle difference between the first angle and the second angle comprises the following steps:
calculating the first angle, wherein a straight path between a position of each moving touch object at the first time point and a position of the motionless touch object constitutes a first line, and the first angle is defined between the first line and a reference line;
calculating the second angle, wherein a straight path between a position of each moving touch object at the second time point and the position of the motionless touch object constitutes a second line, and the second angle is defined between the second line and the reference line; and
calculating a difference between the first angle and the second angle to be determined as the angle difference.
